(19) United States
(12) Patent Application Publication
(10) Pub. No.: US 2016/0253703 A1
(43) Pub. Date: Sep. 1, 2016

(54) METHODS, SYSTEMS, APPARATUSES, AND/OR NON-TRANSITORY COMPUTER READABLE MEDIA FOR PROVIDING WEB CONTENT FOR WEB PAGES BASED ON PRIORITY OF THE WEB CONTENT

(71) Applicant: NAVER Corporation, Seongnam-si (KR)

(72) Inventors: Sang Chul LEE, Seongnam-si (KR); Hyun Mee CHUNG, Seongnam-si (KR)

(21) Appl. No.: 15/054,282

(22) Filed: Feb. 26, 2016

(30) Foreign Application Priority Data
Feb. 26, 2015 (KR) 10-2015-0027264

(51) Int. Cl. G06Q 30/02; G06F 17/30; G06F 17/21; G06T 11/00; G06F 3/0484; G06F 17/22

(52) U.S. Cl. CPC G06Q 30/0256; G06F 3/04842; G06F 17/2247; G06F 17/214; G06T 11/001; G06F 17/30864

(57) ABSTRACT

A system, apparatus, method, and non-transitory computer readable medium for providing a web page displaying a first content region and a second content region includes obtaining a display priority of the first content region and second content region, determining a display position of the second content region and a display position of the first content region according to the display priority of the first content region, and providing a web page displaying the first content region on the display position of the first content region and the second content region on the display position of the second content region and emphasizing a display of the second content region if the display priority of the second content region becomes lower.

### CROSS-REFERENCE TO RELATED APPLICATION

This application claims the benefit of priority to Korean Patent Application No. 10-2015-0027264, filed on Feb. 28, 2015, in the Korean Intellectual Property Office (KIPO), the entire contents of which is incorporated herein in its entirety by reference.

### BACKGROUND

1. Field

One or more example embodiments relate to methods, systems, apparatuses, and/or non-transitory computer readable media for providing web pages.

2. Description of the Related Art

In most cases, the Internet is used to obtain information users desire. If a query language is input, search engines and/or servers residing on the Internet provide information regarding the input query language and simultaneously provides advertisement data related to the input query language, thereby increasing and/or maximizing an advertisement effect. Owing to these merits, Internet advertisements are spotlighted by advertisers as beneficial places for exposing advertisement data.

A search advertisement method that is one of the Internet advertisement methods receives a previous registration of an advertisement related to a keyword through an advertiser bidding for the keyword, receives a search keyword from a user, and provides a registered advertisement list related to the keyword as a search result.

Recently provided search services receive a search keyword from a user and provide a registered advertisement list related to the keyword and the normal web content that comprise the search result together.

However, there is a demand for a new exposure method of a search advertisement model that provides a user with a satisfactory search result and simultaneously increases the amount of attention the provided advertisement receives from the viewer, thereby increasing the advertisement's effect.

### SUMMARY

One or more example embodiments include methods, systems, apparatuses, and/or non-transitory computer readable media for providing web pages.

Additional aspects will be set forth in part in the description which follows and, in part, will be apparent from the description, or may be learned by practice of the presented example embodiments.

According to one or more example embodiments, a method of providing a web page includes obtaining, using at least one processor, obtaining, using at least one processor, a display priority of at least one first priority web page region, determining, using the at least one processor, a display position of at least one second priority web page region and a display position of the at least one first priority web page region according to the display priority of the first priority web page region, providing, using the at least one processor, a web page displaying the second priority web page region on the determined display position of the second priority web page region and the first priority web page region on the determined display position of the first priority web page region, and updating, using the at least one processor, the provided web page by emphasizing the display of the first priority web page region if a current display priority of the first priority web page region becomes lower.

According to some example embodiments, the method may also include determining the display position of the first priority web page region to be at the top of the web page if the current display priority of the first priority web page region becomes higher.

According to some example embodiments, the web page includes a plurality of display positions of which a priority value is assigned, the obtaining includes further obtaining a display priority of the second priority web page region, and the determining includes determining a display position of a region having a higher display priority among the second priority web page region and the first priority web page region to be a display position having a higher priority among the plurality of display positions included in the web page.

According to some example embodiments, the determining includes further obtaining a display priority of the second priority web page region, and determining a display position of a region having a higher display priority among the second priority web page region and the first priority web page region to be a top of the web page.

According to some example embodiments, the obtaining includes further obtaining a display priority of the second priority web page region, the web page displays the second priority web page region and the first priority web page region in a vertical line format, and the determining includes determining the display position of the second priority web page region and the display position of the first priority web page region such that the second priority web page region and the first priority web page region are enumerated on the web page according to the priority order.

According to some example embodiments, the method may also include obtaining, using the at least one processor, user selection information of the first priority web page region, and the obtaining includes determining the display priority of the first priority web page region based on the user selection information of the first priority web page region.

According to some example embodiments, the method may also include obtaining of the user selection information includes further obtaining updated user selection information of the second priority web page region, and generating the display priority of the first priority web page region based on the user selection information of the second priority web page region and the user selection information of the first priority web page region.

According to some example embodiments, the method may also include obtaining, using the at least one processor, user selection information of the first priority web page region and user selection information of the second priority web page region, and the obtaining includes determining a region having a higher click-through rate (CTR) among the second priority web page region and the first priority web page region to have a higher display position based on a CTR of the second priority web page region in which the user selection information of the second priority web page region is collected and a CTR of the first priority web page region in which the user selection information of the first priority web page region is collected.

According to some example embodiments, the method may also include providing includes emphasizing the display of the first priority web page region by using at least one emphasizing type including: increasing a size of content displayed on the first priority web page region, changing a color of the content, further displaying a desired image previously stored in the first priority web page region, changing a format of text included in content, increasing a size of the first priority web page region, and displaying a background of the first priority web page region in a desired color.

According to some example embodiments, the method may also include providing includes emphasizing the display of the first priority web page region when the display position of the first priority web page region is lower than a desired reference position of the web page.

According to some example embodiments, the method may also include emphasizing the display of the first priority web page region by using a desired first emphasizing type when the display position of the first priority web page region is lower than a desired first reference position of the web page and is higher than a second reference position located below the first reference position, and emphasizing the display of the first priority web page region by using a desired second emphasizing type when the display position of the first priority web page region is lower than the second reference position.

According to one or more example embodiments, an apparatus for providing a web page includes a memory having computer readable instructions stored thereon, determine a display position of a second content region and a display position of the first content region according to the display priority of the first content region, the second content region associated with content received from a second content source, providing a web page displaying the second content region on the display position of the second content region and the first content region on the display position of the first content region, and updating the provided web page by emphasizing the display of the first content region if the current display priority of the first content region becomes lower.

According to some example embodiments, the apparatus may also include updating the provided web page includes obtaining an updated display priority of the first content region in real-time and using the updated display priority as the current display priority.

According to some example embodiments, the apparatus may also include at least one processor that is further configured to receive a search query from a user terminal, determine search results related to the search query, and provide webpage content related to the search query as the first content region, and the search results as the second content region.

According to some example embodiments, the webpage content includes content related to a search theme associated with the search query.

According to some example embodiments, the apparatus may also include at least one processor that is further configured to determine the display position of the first content region to be at the top of the web page if the current display priority of the first content region becomes higher.

According to some example embodiments, the apparatus may also include the web page includes a plurality of display positions, each of the plurality of display positions including a priority value, the obtaining includes further obtaining a display priority of the second content region, and the determining includes determining a display position of a region having a higher display priority among the first content region and the second content region based on the respective priority values of the content regions.

According to some example embodiments, the apparatus may also include the first content region includes a plurality of first content regions, and the second content region includes a plurality of second content regions.

According to one or more example embodiments, a non-transitory computer readable recording medium having recorded thereon computer readable instructions, which when executed by at least one processor, configures the at least one processor to obtain a display priority of a first priority web page region, determine a display position of a second priority web page region and a display position of the first priority web page region according to the display priority of the first priority web page region, provide a web page displaying the second priority web page region on the display position of the second priority web page region and the first priority web page region on the display position of the first priority web page region, and update the provided web page by emphasizing the display of the first priority web page region if the current display priority of the first priority web page region becomes lower.

According to some example embodiments, the non-transitory computer readable recording medium may also include updating the provided web page includes obtaining an updated display priority of the first priority web page region in real-time and using the updated display priority as the current display priority.

Such normal and specific aspects may be set forth by using systems, methods, apparatuses, and non-transitory computer readable media or a combination of systems, methods, apparatuses, and non-transitory computer readable media.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 is a diagram of a configuration of a service providing system according to at least one example embodiment;

FIG. 2 is a block diagram of a configuration of a web page providing apparatus included in a server of FIG. 1, according to at least one example embodiment;

FIG. 3 a flowchart of a web page providing method according to at least one example embodiment;

FIG. 4 illustrates a web page according to at least one example embodiment;

FIG. 5 illustrates an example of a web page according to at least one example embodiment;

FIG. 6 illustrates another example of a web page according to at least one example embodiment; and

FIG. 7 illustrates another example of a web page according to at least one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

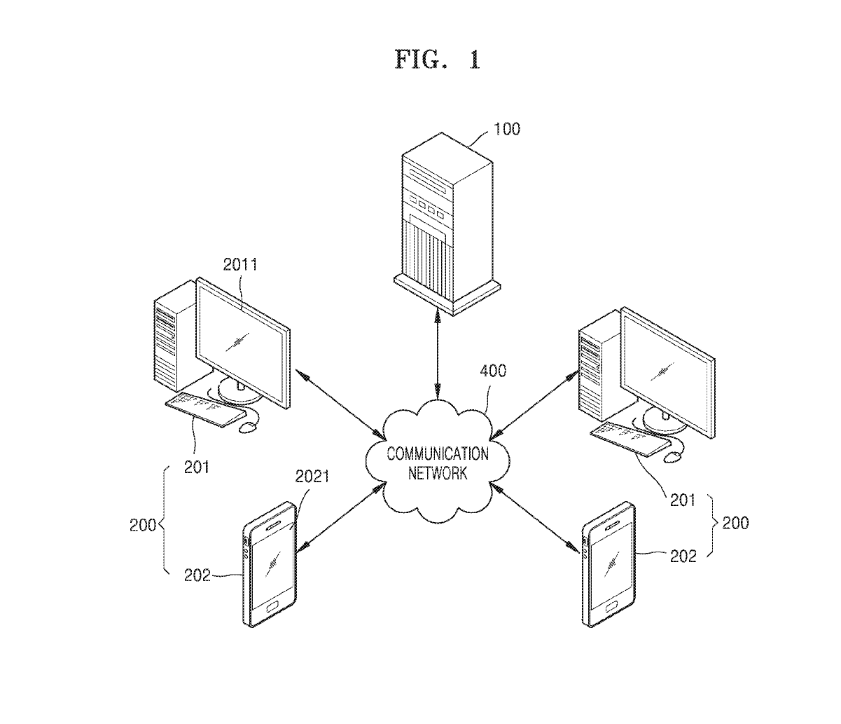

FIG. 1 is a diagram of a configuration of a service providing system according to at least one example embodiment.

Referring to FIG. 1, the service providing system according to at least one example embodiment may include a server 100, a user terminal 200, and a communication network 400 connecting the server 100 and the user terminal 200 with each other.

The service providing system according to at least one example embodiment may provide a content page, search results user interface, and/or a web page (hereinafter referred to as search results, web page, or search results web page) to the user terminal 200. The search results may include a user interface page related to the search providing system, such as an application (“app”) user interface display provided on a display for a smartphone, tablet, wearable device, smart device, etc., a television display, etc. The service providing system according to at least one example embodiment may provide a search service. The search service may provide a search result corresponding to a search query input (e.g., search word, keyword, voice input, data input, music input, image input, etc.) by, for example, the user terminal 200. The search result may include a first content type received from a first content source, such as normal content (e.g., information related to the search query input, webpage content, audio content, video content, text content, data content, etc.) received from a normal web content source (e.g., information related to the search results, a website, a social media account, a video streaming service, a music streaming service, files transferred from another terminal, video/audio from another terminal, screen sharing/mirroring, etc.). For example, the first content source may be the search database 140 and/or the advertising database 145, etc. The search result may also include a second content type received from a second content source, such as advertising content received from an advertising content source (e.g., advertisers, an advertising network, etc.), and/or an additional normal web content source. For example, the second content source may be the advertising database 145 and/or the search database 140, etc. The first content type may be assigned for display on a first priority web page region of the web page to be displayed, and the second content type may be assigned for display on a second priority web page region of the web page. While the example embodiment is discussed in reference to a first and second content type, content source, and priority web page region, the example embodiments are not limited thereto and may include any number of content types, content sources, and priority web page regions.

The service providing system according to at least one example embodiment may receive the search query from the user terminal 200 and provide a web page displaying the search result corresponding to the search query to the user terminal 200. The web page may include a first content region (and/or first priority web page region) displaying a first content type (e.g., advertisement content, etc.) and a second content region (and/or second priority web page region) displaying the second content type (e.g., the normal content, etc.). Display positions of the first content region, the second content region, etc., may be variously controlled. While example embodiments will be referred to as including a normal region and advertisement region for the sake of clarity and convenience, the example embodiments are not limited thereto and may include other content types and/or content received from different content sources.

The web page may include a plurality of normal regions displaying different types of normal content and the advertisement region displaying the advertisement content. Each of the plurality of normal regions may display different types of normal content. For example, a first normal region may display a blog search result, a second normal region may display a café search result, a third normal region may display a website search result, a fourth normal region may display a social media account information, a fifth normal region may display a ticker displaying news headlines, sports scores, stock quotes, a sixth normal region may display/provide video and/or audio content, etc. The example embodiments are not limited to the above-described example.

Referring to FIG. 1, the user terminal 200 may include a communication terminal capable of using a web service in a wired and wireless communication environment. In this regard, the user terminal 200 may be a personal computer 201 of a user or a portable terminal 202 of a user, but are not limited thereto, and may be any terminal that has an application capable of web browsing and/or access a communication network (e.g., the Internet, an intranet, etc.), such as a smartphone, a laptop, a smart device, a tablet, a wearable device, an Internet of Things (loT) device, a personal digital assistant (PDA), a gaming console, etc.

The user terminal 200 may include display units 2011 and 2021 displaying screens and an input apparatus receiving data from the user. The input apparatus may include, for example, a keyboard, a mouse, a track ball, a microphone, a button, a touch panel, etc. but is not limited thereto.

The communication network 400 may act to connect the user terminal 200 and the server 100 to each other. For example, the communication network 400 may provide an access path for the user terminal 200 to access the server 100 and transmit and receive packet data, such as the Internet, an intranet, a wide area network (WAN), a local area network (LAN), a personal area network (PAN), a cell network, etc.

The server 100 may provide the web page to the user terminal 200. For example, the server 100 may receive the search query from the user terminal 200 and provide the web page displaying the search result corresponding to the search query. Although not shown in FIG. 1, the server 100 according to at least one example embodiment may include memory, an input and output unit, at least one processor, a storage device having one or more computer programs stored thereon, a controller, a network interface, etc.

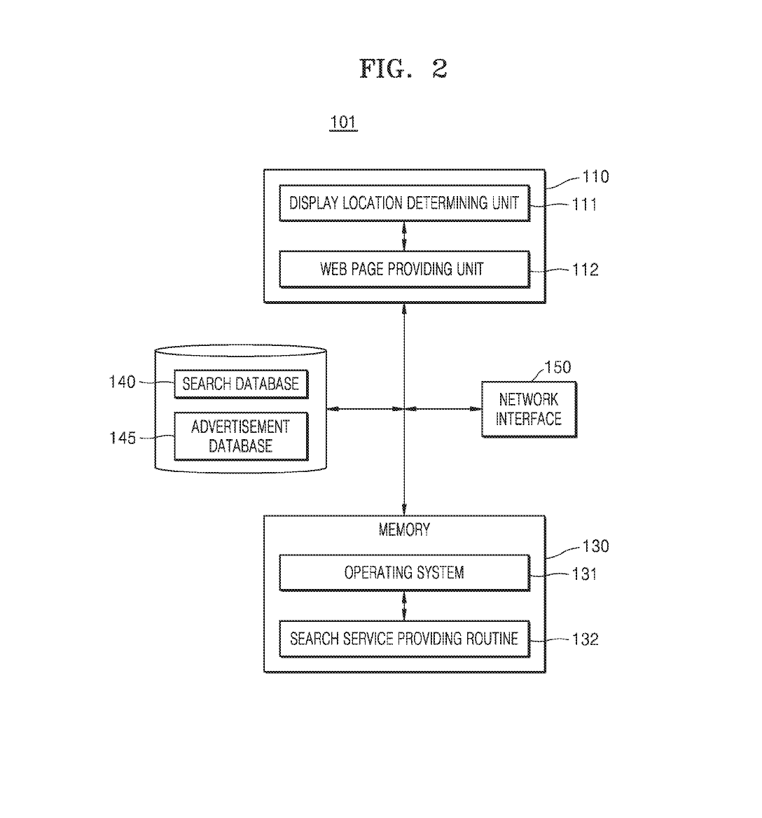

FIG. 2 is a block diagram of a configuration of a web page providing apparatus 110 included in the server 100 of FIG. 1.

Referring to FIG. 2, a web page providing apparatus 101 according to at least one example embodiment may be configured as a single web page providing apparatus 101 or a plurality of web page providing apparatuses communicating over a network (not shown). The web page providing apparatus(es) include at least one processor 110, a bus 120, a memory 130, a search database 140, an advertisement database 145, a network interface 150, etc. The memory 130 may include an operating system (OS) 131 and a search service providing routine 132. According to some example embodiments, when the search database and advertisement database are not stored in a single database and/or apparatus due to memory storage capacity issues, computer resource issues, network performance issues, computer security issues, etc., the web page providing apparatus 101 may be configured using a plurality of web page providing apparatuses that are provided for the search database and/or advertisement database and may thereby be correlated to one another. The search database 140 may include normal content related to the search providing service, such as the web content related to the user's search query, desired and/or prestored web content, computer programs related to the search engine algorithms and/or functionality, etc. The advertising database 145 may include advertising content related to an advertising providing service, such as advertising content to be provided to a user, desired and/or prestored advertising content, computer programs related to the advertising service algorithms and/or functionality, etc. Additionally, the search database 140 and advertising database 145 may receive additional content from other sources via the network interface 150, a disk drive (not shown), and/or other inputs.

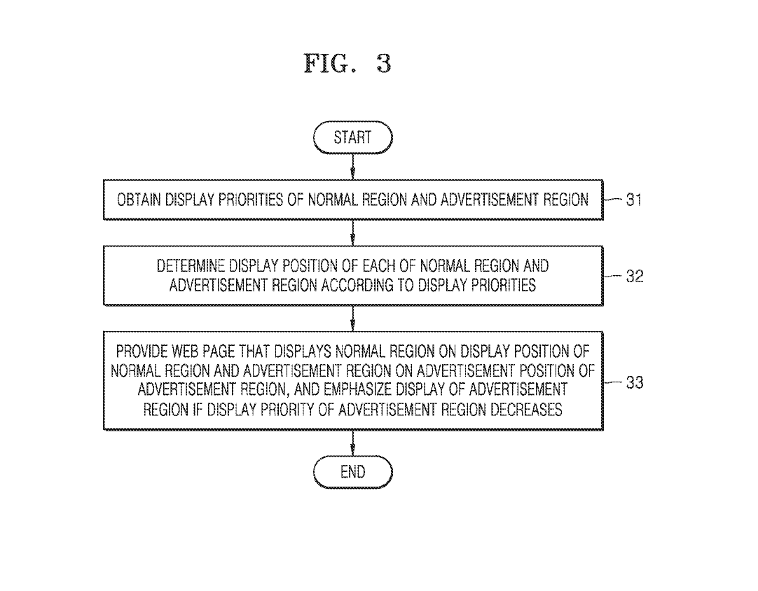

The processor 110 may include a display location determining unit 111, and/or a web page providing unit 112. The display location determining unit 111 and web page providing unit 112 may be configured to perform operations 31 through 33 of FIG. 3. The processor 110 may be configured by executing the computer readable instructions associated with the search service providing routine 132 stored in the memory 130. According to other example embodiments, the apparatus 101 may include a greater or lesser number of constituent elements than the number of constituent elements shown in FIG. 3.

The memory 130 may include a mass storage device, such as a random access memory (RAM), a read only memory (ROM), a disc drive, a solid state drive, an optical drive, etc., as a non-transitory computer-readable storage medium. Also, program codes (e.g., computer readable instructions) for the Operating System (OS) 131 and the search service providing routine 132 may be stored in the memory 130. Such software constituent elements may be loaded from another non-transitory computer-readable storage medium separate from the memory 130 using a drive mechanism (not shown). The other non-transitory computer-readable storage medium may include, for example, a floppy disk, a hard disk, a tape storage device, a Bluray/DVD/CD-ROM, a memory card, etc. Software constituent elements may be loaded to the memory 130 through the network interface 150 instead of, or in addition to, the non-transitory computer-readable storage medium.

The bus 120 enables communication and data transmission between the constituent elements of the web page providing apparatus 101. The bus 120 may be configured using a high-speed serial bus, a parallel bus, a storage area network (SAN), and/or other appropriate communication technology.

The network interface 150 may be a computer hardware constituent element for connecting the web page providing apparatus 101 to a communication network (e.g., the communication network 400 of FIG. 1, etc.). The network interface 150 may connect the web page providing apparatus 101 to the computer network through a wireless and/or wired connection. Additional computer apparatuses (e.g., additional servers, user terminals, etc.) associated with the search service may be connected to the same communication network. Other computer apparatuses and/or computing devices, such as personal computers, servers, distributed computer systems, cloud computer systems, artificial intelligence systems, supercomputers, smartphones, tablets, smart devices, Internet of Things (IOT) devices, wearable devices, gaming devices, personal digital assistants (PDA), etc., may also connect to the same computer network and may perform operations related to the search service provided by the web page providing apparatus 101, such as access data, submit queries, store data to, retrieve data from, perform calculations on, etc.

The processor 110 may be configured to process computer-readable instructions of various computer programs by performing a basic arithmetic operation, a logic operation, and/or an input/output operation of the web page providing apparatus 101. The computer-readable instructions may be provided from the memory 130 and/or the network interface 150 to the processor 110 through the bus 120. The processor 110 may be configured to execute program codes for the display location determining unit 111 and/or web page providing unit 112. These and other program codes may be stored in a storage device such as the memory 130.

When executed by a processor, such as the processor 110, the computer-readable instructions associated with the display location determining unit 111 and/or web page providing unit 112 transform the processor 110 into a special purpose processor configured to perform at least operations 31 through 33 of FIG. 3.

The web page providing apparatus 110 may be included in the server 100 but is not necessarily limited thereto. The web page providing apparatus 110 may be included in the user terminal 200 according to some example embodiments.

The web page providing apparatus 110 according to at least one example embodiment may provide a web page displaying a normal region and an advertisement region. The web page providing apparatus 110 according to at least one example embodiment may provide a web page including a search result with respect to an obtained search query. The web page may include the normal region displaying a search result of normal content and the advertisement region displaying a search result of advertisement content.

The display position determining unit 111 may obtain a display priority of the advertisement region and determine display positions of the normal region and the advertisement region on the web page according to the display priority of the advertisement region. In other words, the web page may include a plurality of display regions that correspond to a display priority list and the one or more advertisement regions, normal regions, etc., may be arranged on the web page according to the desired priority list. The display position determining unit 111 may further obtain a display priority of the normal region and determine the display positions of the normal region and the advertisement region according to the display priority of the advertisement region and the display priority of the advertisement region. The web page providing unit 112 may provide the web page displaying the normal region and the advertisement region based on the display positions of the normal region and the advertisement region determined by the display position determining unit 111.

The web page may display both the normal region and the advertisement region. The display positions of the normal region and the advertisement region on the web page may be variably set.

According to at least one example embodiment, the display positions of the normal region and the advertisement region may be determined according to a desired (or alternatively, predetermined) parameter. The parameter may correspond to the display priorities of the normal region and the advertisement region. For example, the web page may display one normal region and one advertisement region, a display priority of the normal region may be set as second, and a display priority of the advertisement region may be set as first. In this regard, the display positions of the normal region and the advertisement region on the web page may be determined using a desired and/or preset method according to their respective display priorities. For example, the advertisement region having a first display priority may be displayed on top of the web page, and the normal region having a second display priority may be displayed on the bottom of the web page. As another example, the advertisement region having the first display priority may be displayed above the normal region having the second display priority on the top of the web page. Additionally, the first display priority may correspond to the body of the web page, the second display priority may correspond to a first side of the web page, the third display priority may correspond to a second side of the web page, and the fourth display priority may correspond to the bottom of the web page. While only a first through fourth display priority is discussed with the example embodiments, the example embodiments are not limited thereto and may include more or less display priorities and display regions.

According to at least one example embodiment, the display priorities of the normal region and the advertisement region may be set as variable values by a manager. According to another example embodiment, the display priorities of the normal region and the advertisement region may be changed according to a desired and/or preset rule. If the display priorities are changed, the display position determining unit 111 may change the display positions of the normal region and the advertisement region in correspondence to the changed display priorities.

A rule for variably determining the display priorities may be variously designed. For example, the display position determining unit 111 may obtain user selection information feedback from the user terminal 200 after the web page is provided to the user terminal 200 and determine the display priorities of the normal region and the advertisement region by using the obtained user selection information. The user selection information may be obtained with respect to each of the normal region and the advertisement region. The display position determining unit 111 may determine the display priorities of the normal region and the advertisement region according to a result of comparing the user selection information of each of the normal region and the advertisement region.

For example, the display position determining unit 111 may obtain the user selection information regarding one or more of the normal region and/or one or more of the advertisement region from the user terminal 200 after the web page displaying the normal region and the advertisement region is provided to the user terminal 200 and may store the obtained user selection information in memory. The display position determining unit 111 may repeatedly perform operations of obtaining and storing the user selection information. The user selection information of the normal region may include information regarding whether a user has selected the normal region while the user terminal 200 displays the web page, the amount of time that the normal region has been displayed and/or focused on in the user's display screen (e.g., web browser screen, app screen, user interface screen, etc.), whether content in the normal region has been interacted with (e.g., user input into a search interface, user input of voice commands, user input of touch gestures, input of other user input types, etc.), whether content (e.g., audio/video content, game content, download of content, etc.) has been viewed and/or has played, etc. The user selection information of the advertisement region may also include information regarding whether the user has selected the advertisement region while the user terminal 200 displays the web page, has viewed the advertisement region, has heard the advertisement associated with the advertisement region, etc.

The user selection information of the normal region and the user selection information of the advertisement region may be collected in the memory. The display position determining unit 111 may calculate a click-through rate (CTR) with respect to each of the normal region and the advertisement region from the collected user selection information. The CTR may indicate a rate of a user click with respect to an exposure.

The display position determining unit 111 may determine the display priorities of the normal region(s) and/or the advertisement region(s) based on a comparison result of a CTR of the normal region(s) and a CTR of the advertisement region(s). According to various example embodiments, there may be a plurality of normal regions and a single advertisement region on a web page, a single normal region and a plurality of advertisement regions on a web page, a plurality of normal regions and a plurality of advertisement regions on a web page, at least one normal region and no advertisement regions, at least one advertisement region and no normal region, etc. The display position determining unit 111 may determine a region having a higher CTR to have a higher display priority based on the comparison result of the CTR of the normal region and the CTR of the advertisement region. For example, the display position determining unit 111 may determine the normal region and the advertisement region to have higher display priorities in a higher CTR order.

The display position determining unit 111 may change the display priorities in real time according to CTRs calculated. According to another example embodiment, the display position determining unit 111 may check the CTRs calculated in real time periodically or non-periodically to change the display priorities periodically or non-periodically.

For example, assuming that the web page displays one normal region and one advertisement region, a CTR of the advertisement region is higher than a CTR of the normal region, a display priority of the advertisement region is set as first, and a display priority of the normal region is set as second. In this case, the web page providing unit 112 may provide the web page that displays the advertisement region having a first display priority on the top of the web page and displays the normal region having a second display priority on the bottom of the web page to the user terminal 200.

However, if the CTRs are updated in real time and the CTR of the advertisement region is lower than the CTR of the normal region, the display position determining unit 111 may change the display priority of the advertisement region to second and the display priority of the normal region to first. The web page providing unit 112 may provide a web page that displays the normal region having the first display priority on the top of the web page and displays the advertisement region having the second display priority on the bottom of the web page to the user terminal 200. In the above-described example, the CTR may be replaced with a click number.

The display priorities of the advertisement region and the normal region may be set irrespective of search queries. However, the display priorities of the advertisement region and the normal region may be set in association with search queries. For example, the display priorities of the advertisement region and the normal region may be independently set with respect to each search query input by the user terminal 200. To this end, the display position determining unit 111 may obtain user selection information in correspondence to search queries, calculate CTRs in correspondence to the search queries, and determine the display priorities of the advertisement region and the normal region in correspondence to the search queries.

Additionally, the display priorities of the advertisement region and the normal region may be set in association with themes of search queries (e.g., search query categories, search query topics, etc.). For example, a theme may include queries related to a specific television program, movie, sports team, politician, musician, actor, video game, etc. Additionally, the themes may be associated with related search queries/topics that users have desired information about, and/or conducted related/proximate searches for, such as information about a first company's product and then a competitor's product similar to the first product, news about a company and then real-time stock information about the company, news about a sports team and then biographical information about a star player on that sports team, information about a product and then websites selling the product, etc. The display position determining unit 111 may obtain user selection information in correspondence to themes of search queries, calculate CTRs in correspondence to the themes of the search queries, and determine the display priorities of the advertisement region and the normal region in correspondence to the themes of the search queries. In this regard, the display positions of the advertisement region and the normal region may be differently displayed on the web page according to the themes of the search queries input by the user. A list of a plurality of search queries corresponding to each theme of the search queries may be stored or may be renewed/updated using a learning classification method.

The CTRs of the advertisement region and the normal region may have different tendencies according to search queries and/or themes of search queries. For example, users may select the advertisement region more than the normal region with respect to a specific search query and may select the normal region more than the advertisement region with respect to another specific search query. The display position determining unit 111 according to at least one example embodiment may independently calculate the CTRs according to the search queries and/or the themes of the search queries to set the display priorities of the advertisement region and the normal region, thereby greatly enhancing user convenience.

According to at least one example embodiment, the display position determining unit 111 may determine the display position of the advertisement region to be the top of the web page if the display priority of the advertisement region is higher. According to at least one example embodiment, the display position determining unit 111 may determine a display position of a region having a higher priority among the advertisement region and the normal region to be the top of the web page. The advertisement region and the normal region may be enumerated from the top of the web page in a higher display priority order.

According to at least one example embodiment, the web page may include a plurality of display positions having desired and/or preset priorities. The display position determining unit 111 may determine a display position of a region having a higher priority among the advertisement region and the normal region as a display priority having a higher priority among the plurality of display positions included in the web page. For example, the web page may include a first display position having a first priority and a second display position having a second priority. The display position determining unit 111 may determine a display position of a region having a higher display priority among the normal region and the advertisement region to be the first display position and may determine a display position of the other region to be the second display region.

According to at least one example embodiment, the web page may display the advertisement region and the normal region in a vertical line (e.g., a column user interface format, a list, etc.). The display position determining unit 111 may determine the display position of the advertisement region to be the top of the web page if the display priority of the advertisement region increases. Accordingly, the normal region and the advertisement region may be enumerated from the top of the web page in a higher display priority order, but is not limited thereto and may be enumerated in any other format. According to at least one example embodiment, the web page may display the advertisement region and the normal region in a horizontal line (e.g., row user interface format, a paragraph format, etc.). The display position determining unit 111 may determine the display position of the advertisement region to be the left of the web page if the display priority of the advertisement region becomes higher. Accordingly, the normal region and the advertisement region may be enumerated from the left of the web page in a higher display priority order, but is not limited thereto and may be enumerated in any other format.

The web page providing unit 112 may provide the web page that displays the normal region on the display position of the normal region and displays the advertisement region on the display region of the advertisement region. The web page providing unit 112 may emphasize and display the advertisement region if the display priority of the advertisement region decreases.

The web page providing unit 112 may use various desired and/or preset emphasizing methods to emphasize the display of the advertisement region. For example, emphasizing methods may include a combination of one or more methods among a method of increasing a size of content displayed on a region, a method of changing a color of the content, a method of further displaying a desired (or alternatively, predetermined) image previously stored in the region, a method of changing a format of text included in content, a method of increasing a size of the region, and a method of displaying a background of the region in a desired and/or preset color, etc. The method of changing the format of text may include increasing a font size of text, displaying text in bold, or displaying a bullet that is a paragraph sign in front of text, etc. The web page providing unit 112 may use the above-described various emphasizing methods to emphasize a display of the advertisement region, but is not limited thereto.

A reference of the display position of the advertisement region for emphasizing the display of the region may be variously set. For example, the web page providing unit 112 may emphasize and display the advertisement region when the display position of the advertisement region is lower than a desired and/or preset reference position on the web page. The reference position may be set as, for example, a position that is half of a length of the web page.

The reference position may be set as a plurality of reference positions. For example, a desired (or alternatively, predetermined) position of the web page may be set as a first reference position, and a position lower than the first reference position may be set as a second reference position. The web page providing unit 112 may not emphasize the display of the advertisement region when the display position of the advertisement region is higher than the first reference position, may emphasize the display of the advertisement region by using a desired and/or preset first emphasizing method when the display position of the advertisement region is lower than the first reference position and is higher than the second reference position, and may emphasize the display of the advertisement region by using a desired and/or preset second emphasizing method when the display position of the advertisement region is lower than the second reference position.

The first emphasizing method and the second emphasizing method may be desired and/or preset as display methods for emphasizing the display of the advertisement region. However, the second emphasizing method may be set to have a higher emphasizing effect than the first emphasizing method. For example, the first emphasizing method may increase a font size of the advertisement region by 1, and the second emphasizing method may increase the font size of the advertisement region by 2. Additionally, the first emphasizing method may increase a font size of the advertisement region by 1, and the second emphasizing method may increase the font size of the advertisement region by 1 and change a background color of the advertisement region to a specific color. The above-described increase in the font size may be on the basis of a base font size. The base font size may be desired and/or preset in the same way with respect to the advertisement region and the normal region. The first emphasizing method and the second emphasizing method may be variously set within a range in which a difference in an emphasizing degree is recognized and thus they are not limited to the above example.

In accordance with at least one example embodiment, the web page providing unit 112 may use an emphasizing method having a higher emphasizing effect on the advertisement region if the display position of the advertisement region further decreases. The web page providing unit 112 may emphasize the display of the advertisement region by steps according to the display position of the advertisement region.

According to at least one example embodiment, the web page may include a plurality of normal regions and one advertisement region. The display position determining unit 111 may obtain display priorities with respect to each of the plurality of normal regions and the advertisement region and thus determine display positions of each of the normal regions and the advertisement region on the web page. The web page providing unit 112 may emphasize a display of the advertisement region according to the display position of the advertisement region to provide the web page.

According to at least one example embodiment, the web page may include a plurality of normal regions and a plurality of advertisement regions. The display position determining unit 111 may obtain the display priorities with respect to each of the plurality of normal regions and the advertisement regions and thus determine display positions of each of the normal regions and the advertisement regions on the web page. The web page providing unit 112 may emphasize a display of each of the advertisement regions according to the display position of each of the plurality of advertisement regions to provide the web page. Each of the plurality of advertisement regions may be emphasized and displayed using different emphasizing methods.

FIG. 3 a flowchart of a web page providing method according to at least one example embodiment.

Referring to FIG. 3, in operation 31, the display position determining unit 111 of FIG. 2 may obtain a display priority of each of a normal region and an advertisement region.

In operation 32, the display position determining unit 111 of FIG. 2 may determine a display position of each of the normal region and the advertisement region on a web page according to the display priority.

In operation 33, the web page providing unit 112 of FIG. 2 may provide the web page that displays the normal region on the display position of the normal region and the advertisement region on the advertisement position of the advertisement region, and may emphasize a display of the advertisement region if the display priority of the advertisement region decreases.

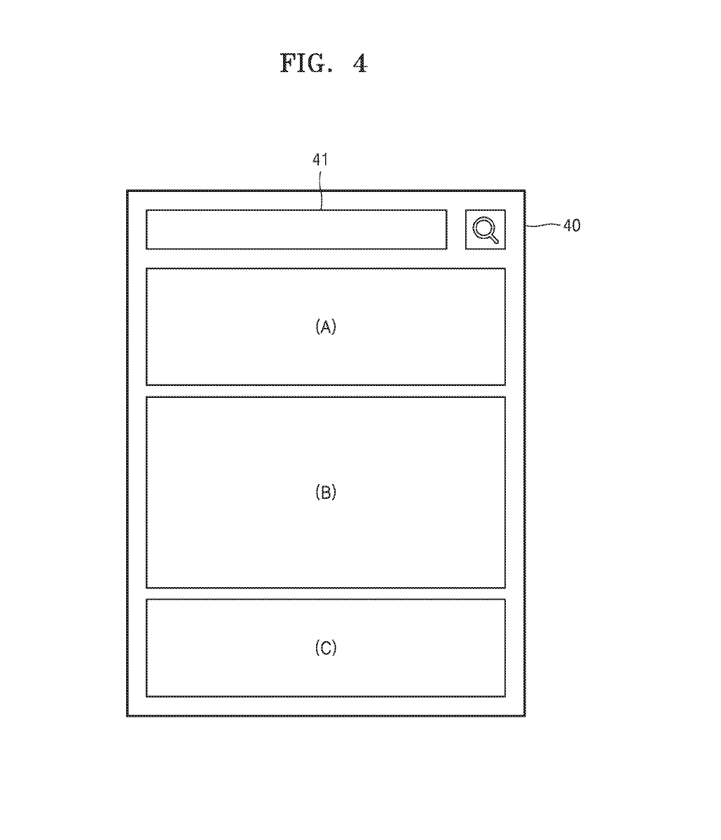

FIG. 4 illustrates a web page 40 according to at least one example embodiment.

Referring to FIG. 4, the web page 40 may include a plurality of display positions A, B, and C and may include a search window 41 for inputting a search query. Each of the display positions A, B, and C may display a normal region or an advertisement region. Each of the display positions A, B, and C may display a search result with respect to a search query input to the search window 41. The normal region may display a normal search result with respect to the search query input to the search window 41. The advertisement region may display an advertisement search result with respect to the search query input to the search window 41. While FIG. 4 illustrates an example embodiment of a web page, the example embodiments are not limited thereto and may contain less or more display positions, display regions, and/or other user interface elements.

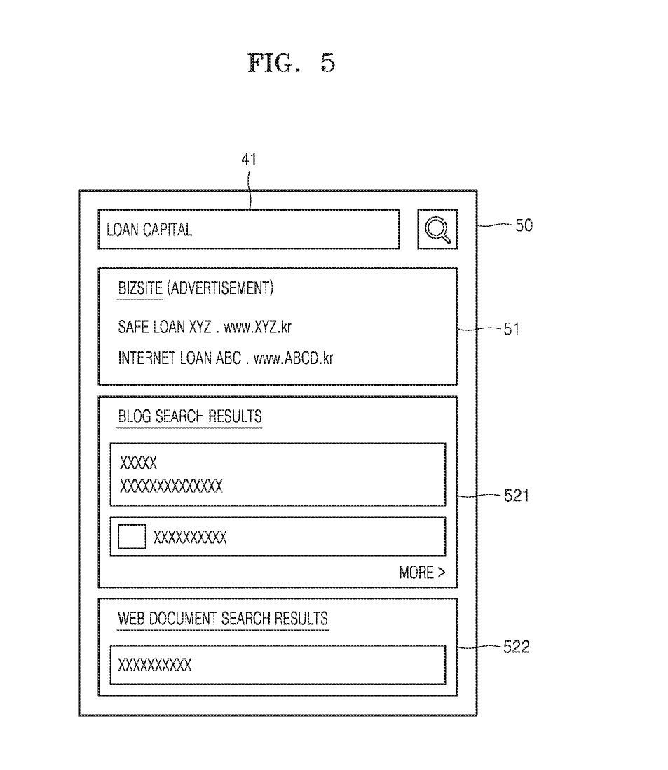

FIG. 5 illustrates an example of a web page 50 according to at least one example embodiment.

The web page 50 of FIG. 5 is an example that displays normal regions 521 and 522 or an advertisement region 51 on the display positions A, B, and C of the web page 40 of FIG. 4.

FIG. 5 illustrates the example in which the advertisement region 51 is displayed on the display position A of FIG. 4, the normal region 521 is displayed on the display position B of FIG. 4, and the normal region 522 is displayed on the display position C of FIG. 4.

Referring to FIG. 5, the web page 50 may display the advertisement region 51, the first normal region 521, and the second normal region 522. A search query “loan capital” may be input to the search window 41. An advertisement search result with respect to the search query may be displayed on the advertisement region 51. Normal search result with respect to the search query may be displayed on the first normal region 521 and the second normal region 522.

The first normal region 521 and the second normal region 522 may display search results for different types of content. For example, the first normal region 521 may display a search result of content “blog” with respect to the search query, and the second normal region 522 may display a search result of content “web document” with respect to the search query. FIG. 5 shows that the first normal region 521 displays a blog search result with respect to “loan capital”, and the second normal region 522 displays a web document search result with respect to “loan capital”.

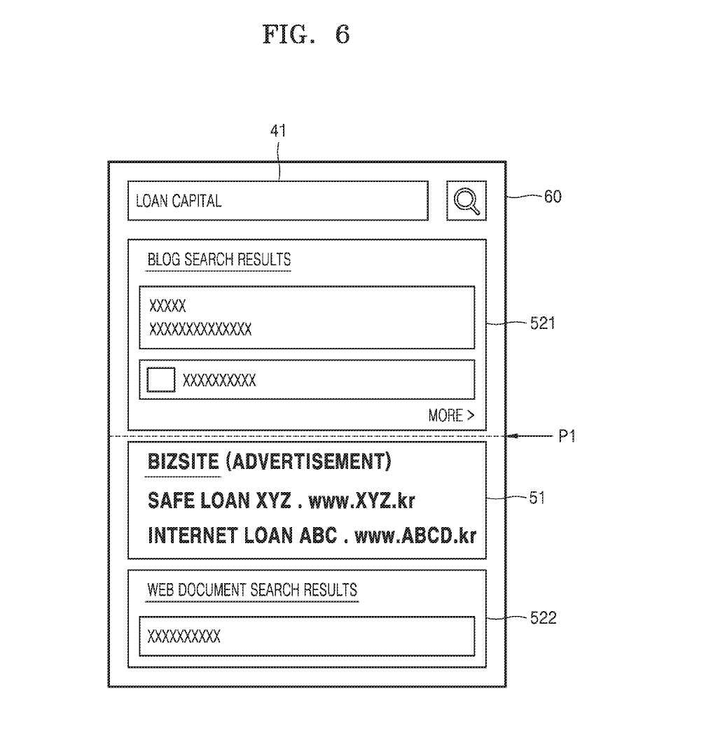

FIG. 6 illustrates another example of a web page 60 according to at least one example embodiment.

The web page 60 of FIG. 6 is another example that displays the normal regions 521 and 522 or the advertisement region 51 on the display positions A, B, and C of the web page 40 of FIG. 4. FIG. 6 illustrates the example in which the normal region 521 is displayed on the display position A of FIG. 4, the advertisement region 51 is displayed on the display position B of FIG. 4, and the normal region 522 is displayed on the display position C of FIG. 4.

The web page 60 of FIG. 6 is a web page provided when a search query is input after the web page 50 of FIG. 5 is provided, and then display positions of the first normal region 521 and the advertisement region 51 are changed due to a difference in user selection information with respect to the first normal region 521 and the advertisement region 51.

As described above, FIG. 5 illustrates the example in which the display position A displays the advertisement 51, and the display position B displays the first normal region 521. However, when the display position determining unit 111 of FIG. 2 obtains the user selection information with respect to the first normal region 521 and the advertisement region 51 from the user terminal 200 and calculates CTRs, if a CTR of the first normal region 521 is higher than a CTR of the advertisement region 51, the display position determining unit 111 of FIG. 2 may determine a display position of the first normal region 521 to be higher than a display position of the advertisement region 51. FIG. 6 illustrates the example of the web page 60 on which the first normal region 521 is displayed above the advertisement region 51 since the display position of the first normal region 521 is determined to be higher than the display position of the advertisement region 51, for example.

Referring to FIG. 6, the web page providing unit 112 of FIG. 2 may provide the web page 60 that emphasizes and displays the advertisement region 51 if a display priority of the advertisement region 51 becomes lower. Referring to FIG. 6, the web page providing unit 112 of FIG. 2 may increase a size of text included in the advertisement region 51 and display the text in bold, for example.

According to at least one example embodiment, a web page providing service may display a region that receives a lot of user selections based on user selection information on the top of a web page according to a specific policy. That is, if the advertisement region 51 does not receive a lot of user selections, the display position of the advertisement region 51 may be moved to the bottom of the web page. The policy may display the region that receives a lot of user selections on the top of the web page in order to provide high access to a resultant satisfying the search needs of a user, thereby enhancing user convenience in real time.

The web page providing unit 112 of FIG. 2 according to at least one example embodiment may emphasize a display of the advertisement region 51 although the advertisement region 51 does not receive a lot of user selections and is moved to the bottom of the web page, thereby allowing the user to recognize the advertisement region 51.

The web page providing unit 112 of FIG. 2 may emphasize and display the advertisement region 51 when the display position of the advertisement region 51 is lower than a desired and/or preset reference position P1 on the web page. The reference position P1 may be set as, for example, a position that is half of a length of the web page but is not limited thereto.

Although FIG. 6 illustrates one reference position P1, according to at least one example embodiment, a plurality of reference positions may be set. When the display position of the advertisement region 51 is lower than at least one reference position among the plurality of reference positions, the web page providing unit 112 may apply a stepwise emphasizing method according to the position of the advertisement region 51 in order to emphasize the display of the advertisement region 51.

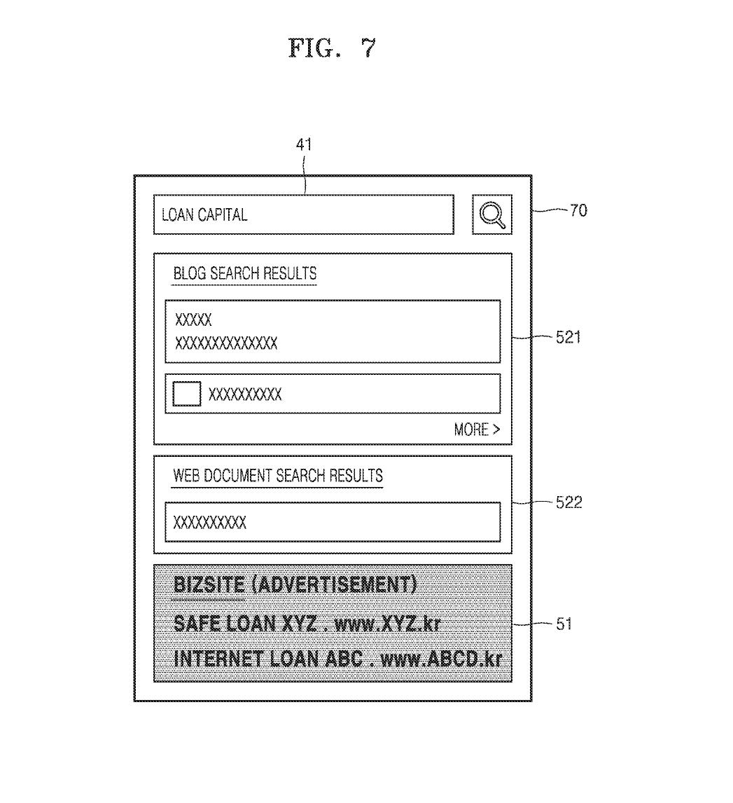

FIG. 7 illustrates another example of a web page 70 according to at least one example embodiment.

The web page 70 of FIG. 7 is another example embodiment that displays the normal regions 521 and 522 or the advertisement region 51 on the display positions A, B, and C of the web page 40 of FIG. 4. FIG. 7 illustrates the example in which the normal region 521 is displayed on the display position A of FIG. 4, the normal region 522 is displayed on the display position B of FIG. 4, and the advertisement region 51 is displayed on the display position C of FIG. 4.

The web page 70 of FIG. 7 is a web page provided when a search query is input after the web page 60 of FIG. 6 is provided, and then display positions of the second normal region 522 and the advertisement region 51 are changed due to a difference in user selection information with respect to the second normal region 522 and the advertisement region 51.

Referring to FIG. 7, the web page providing unit 112 of FIG. 2 may provide the web page 70 that emphasizes and displays the advertisement region 51 if a display priority of the advertisement region 51 becomes lower. Referring to FIG. 7, the web page providing unit 112 of FIG. 2 may increase a size of text included in the advertisement region 51, display the text in bold, and display a background of the advertisement region 51 in a specific color.

Referring to FIGS. 6 and 7, the web page providing unit 112 of FIG. 2 may emphasize the display of the advertisement region 51 by using a desired and/or preset first emphasizing method when the display position of the advertisement region 51 is lower than a first reference position and is higher than a second reference position, and may emphasize the display of the advertisement region 51 by using a desired and/or preset second emphasizing method when the display position of the advertisement region 51 is lower than the second reference position. An example embodiment of applying the first emphasizing method to the advertisement region 51 is illustrated in FIG. 6. An example embodiment of applying the second emphasizing method to the advertisement region 51 is illustrated in FIG. 7.

The second emphasizing method may be set as a method having a higher emphasizing effect than the first emphasizing method. In the example of FIG. 6, the first emphasizing method may increase a font size of text and display the text in block. In the example of FIG. 7, the second emphasizing method may increase the font size of the text, display the text in bold, and additionally display a background color of the advertisement region in a specific color, etc. The first emphasizing method and the second emphasizing method may be variously set within a range in which a difference in an emphasizing degree is recognized and thus they are not limited to the examples of FIGS. 6 and 7.

As described above, a method and an apparatus for providing a web page according to the example embodiments may provide a user with a satisfactory search result and simultaneously increase attention for an advertisement, thereby increasing an advertisement effect.

A method and an apparatus for providing a web page according to at least one example embodiment may show a search result that receives a lot of choices from users to the top of the web page to provide a user with a satisfactory search result and simultaneously increase the user attention of an advertisement, thereby increasing an advertisement effect.

The web page providing method of FIG. 3 according to at least one example embodiment can also be embodied as computer-readable programs and can be embodied in a special purpose digital computer that operates the computer-readable programs by using non-transitory computer-readable recording medium.

Units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An apparatus for providing a web page, the apparatus comprising:
a memory having computer readable instructions stored thereon; and
at least one processor configured to execute the computer readable instructions to,
obtain a display priority of a first content region, the first content region associated with content received from a first content source,
determine a display position of a second content region and a display position of the first content region according to the display priority of the first content region, the second content region associated with content received from a second content source,
providing a web page displaying the second content region on the display position of the second content region and the first content region on the display position of the first content region, and
updating the provided web page by emphasizing the display of the first content region if the current display priority of the first content region becomes lower.

2. The apparatus of claim 1, wherein the updating the provided web page includes obtaining an updated display priority of the first content region in real-time and using the updated display priority as the current display priority.

3. The apparatus of claim 1, wherein the at least one processor is further configured to:
receive a search query from a user terminal;
determine search results related to the search query; and
provide webpage content related to the search query as the first content region, and the search results as the second content region.

4. The apparatus of claim 3, wherein the webpage content includes content related to a search theme associated with the search query.

5. The apparatus of claim 4, wherein the at least one processor is further configured to:
determine the display position of the first content region to be at the top of the web page if the current display priority of the first content region becomes higher.

6. The apparatus of claim 1, wherein:
the web page includes a plurality of display positions, each of the plurality of display positions including a priority value;
the obtaining includes further obtaining a display priority of the second content region; and
the determining includes determining a display position of a region having a higher display priority among the first content region and the second content region based on the respective priority values of the content regions.

7. The apparatus of claim 1, wherein the first content region includes a plurality of first content regions, and the second content region includes a plurality of second content regions.

8. A method of providing a web page, the method comprising:
obtaining, using at least one processor, a display priority of at least one first priority web page region;
determining, using the at least one processor, a display position of at least one second priority web page region and a display position of the at least one first priority web page region according to the display priority of the first priority web page region;
providing, using the at least one processor, a web page displaying the second priority web page region on the determined display position of the second priority web page region and the first priority web page region on the determined display position of the first priority web page region; and
updating, using the at least one processor, the provided web page by emphasizing the display of the first priority web page region if a current display priority of the first priority web page region becomes lower.

9. The method of claim 8, wherein the determining comprises:
determining the display position of the first priority web page region to be at the top of the web page if the current display priority of the first priority web page region becomes higher.

10. The method of claim 8, wherein:
the web page includes a plurality of display positions of which a priority value is assigned;
the obtaining includes further obtaining a display priority of the second priority web page region; and
the determining includes determining a display position of a region having a higher display priority among the second priority web page region and the first priority web page region to be a display position having a higher priority among the plurality of display positions included in the web page.

11. The method of claim 8, wherein:
the determining includes further obtaining a display priority of the second priority web page region, and
determining a display position of a region having a higher display priority among the second priority web page region and the first priority web page region to be a top of the web page.

12. The method of claim 8, wherein:
the obtaining includes further obtaining a display priority of the second priority web page region;
the web page displays the second priority web page region and the first priority web page region in a vertical line format; and
the determining includes determining the display position of the second priority web page region and the display position of the first priority web page region such that the second priority web page region and the first priority web page region are enumerated on the web page according to the priority order.

13. The method of claim 8, further comprising:
obtaining, using the at least one processor, user selection information of the first priority web page region; and
the obtaining includes determining the display priority of the first priority web page region based on the user selection information of the first priority web page region.

14. The method of claim 13, wherein:
the obtaining of the user selection information includes further obtaining updated user selection information of the second priority web page region, and
generating the display priority of the first priority web page region based on the user selection information of the second priority web page region and the user selection information of the first priority web page region.

15. The method of claim 8, further comprising:
obtaining, using the at least one processor, user selection information of the first priority web page region and user selection information of the second priority web page region; and
the obtaining includes determining a region having a higher click-through rate (CTR) among the second priority web page region and the first priority web page region to have a higher display position based on a CTR of the second priority web page region in which the user selection information of the second priority web page region is collected and a CTR of the first priority web page region in which the user selection information of the first priority web page region is collected.

16. The method of claim 8, wherein the providing includes emphasizing the display of the first priority web page region by using at least one emphasizing type including: increasing a size of content displayed on the first priority web page region, changing a color of the content, further displaying a desired image previously stored in the first priority web page region, changing a format of text included in content, increasing a size of the first priority web page region, and displaying a background of the first priority web page region in a desired color.

17. The method of claim 8, wherein the providing includes emphasizing the display of the first priority web page region when the display position of the first priority web page region is lower than a desired reference position of the web page.

18. The method of claim 8, wherein the providing includes emphasizing the display of the first priority web page region by using a desired first emphasizing type when the display position of the first priority web page region is lower than a desired first reference position of the web page and is higher than a second reference position located below the first reference position, and emphasizing the display of the first priority web page region by using a desired second emphasizing type when the display position of the first priority web page region is lower than the second reference position.

19. A non-transitory computer-readable recording medium having recorded thereon computer readable instructions, which when executed by at least one processor, configures the at least one processor to:
obtain a display priority of a first priority web page region;
determine a display position of a second priority web page region and a display position of the first priority web page region according to the display priority of the first priority web page region;
provide a web page displaying the second priority web page region on the display position of the second priority web page region and the first priority web page region on the display position of the first priority web page region; and
update the provided web page by emphasizing the display of the first priority web page region if the current display priority of the first priority web page region becomes lower.

20. The non-transitory computer-readable recording medium of claim 19, wherein the updating the provided web page includes obtaining an updated display priority of the first priority web page region in real-time and using the updated display priority as the current display priority.
